(19) United States
(12) Patent Application Publication
(10) Pub. No.: US 2009/0323322 A1
(43) Pub. Date: Dec. 31, 2009

(54) Lamp Formed of LED Clusters with Controllable coloring parts

(75) Inventor: Robin Lee, Hamberg, NJ (US)

Correspondence Address: Law Office of Scott C Harris Inc, PO Box 1389, Rancho Santa Fe, CA, 92067, US

(73) Assignee: PRODUCTION RESOURCE GROUP L.L.C, New Windsor, NY (US)

(21) Appl. No.: 12/491,369

(22) Filed: Jun. 25, 2009

Related U.S. Application Data
(60) Provisional application No. 61/075,404, filed on Jun. 25, 2008.

(51) Int. Cl. F21V 9/00

(52) U.S. Cl. 362/231

(57) ABSTRACT

Light formed from LEDs which are colored by flags to avoid color degradation.

This application claims priority from provisional application No. 61/075,404, filed Jun. 25, 2008, the entire contents of the disclosure of which is herewith incorporated by reference.

### BACKGROUND

Certain kinds of remotely controlled lights use colored LEDs to produce outputs based on a remote control. For example, a red, green and blue LED may be located in a cluster. Pixel mapping can be effected by controlling the amounts of red green and blue lighting according to a control to produce any desired lighting effect.

### SUMMARY

The present application describes a fully color pixel level controllable LED which is controlled in a special way to avoid color degradation.

One aspect defines a lighting system which obviates these problems by avoiding the color degradation.

### BRIEF DESCRIPTION OF THE DRAWINGS

These and other aspects will now be described in detail with reference to the accompanying drawings, wherein:

FIG. 1 shows an embodiment of a number of pixels with movable flags;

FIG. 2 shows a glass filter in a sliding slot;

FIG. 3 shows a single LED embodiment; and

FIG. 4 shows a four-LED embodiment.

### DETAILED DESCRIPTION

The inventor noticed that in LED style RGB lights, the LEDs degrade, and the color produced by these LEDs accordingly also degrades. Over time, therefore, the lights become less useful. Typically the blue LED has been found to degrade more than the other LEDs, since it burns the hottest. This leads to effective obsolescence of the LED lights.

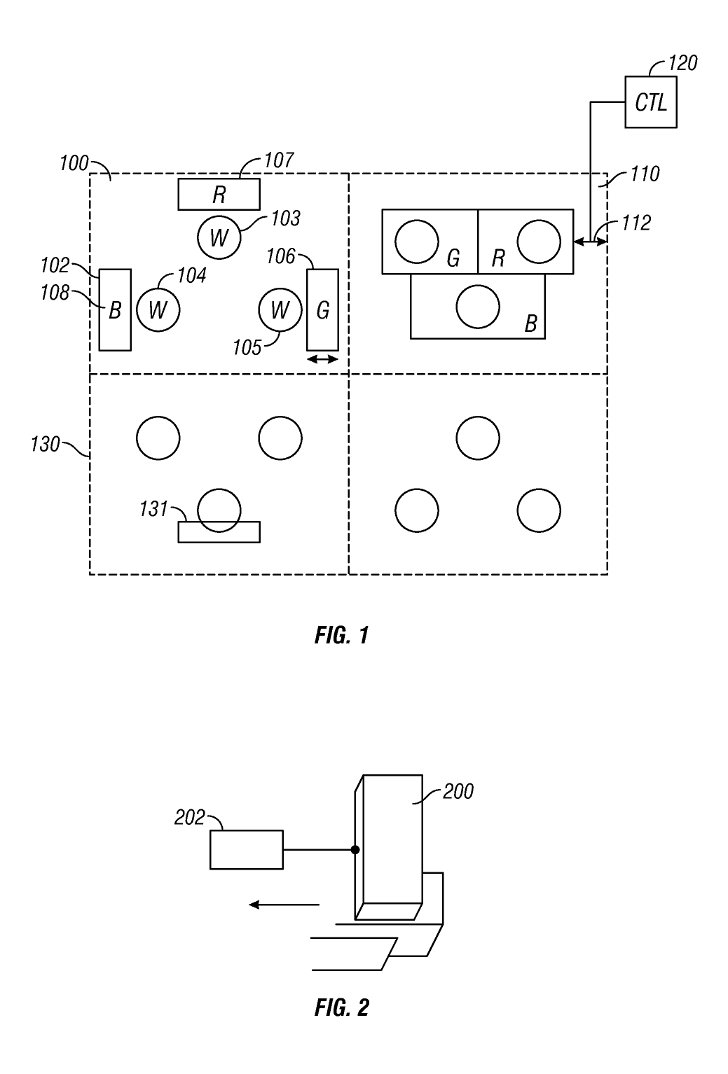

An embodiment addresses this problem by producing a colored LED light which avoids this problem. FIG. 1 shows an embodiment. Each of a plurality of pixels 100, 110 are formed from a cluster 102 of three LED lights. Each of the LED lights in a cluster, 103, 104, 105 is a white LED. A cluster also has movable items referred to herein as flags. The LED 105 for example has a green flag associated therewith as 106. The LED 103 has a red flag 107. The LED 104 includes a blue flag 108. The flags are movable in two directions. For example, the flags are shown in the stowed position in pixel 100. In pixel 110, the flags are shown in their operative position with one flag over each LED. Each flag has an associated actuator shown as 112 which moves the flag to be moved back and forth. Both the LEDs and the actuator are controlled by a controller shown as 120 which may individually control these items to move. This allows pixel mapping, by allowing turning on and off each LED, and also by changing its color. In one embodiment, the actuators 112 may either move the flag to completely cover the pixel or only to partly cover the pixel. In another embodiment, the actuator 112 may move the flag to partly cover the pixel, for example as shown in the pixel 130 where the flag 131 is halfway over the pixel; thereby causing special effects to the pixel.

In an embodiment, the filter may be a glass filter like a slide in a slot as shown in FIG. 2. The glass filter may slide in the slot, according to the actuator. The filter 200 is moved back and forth by the action of the actuator 202, which may for example be a solenoid.

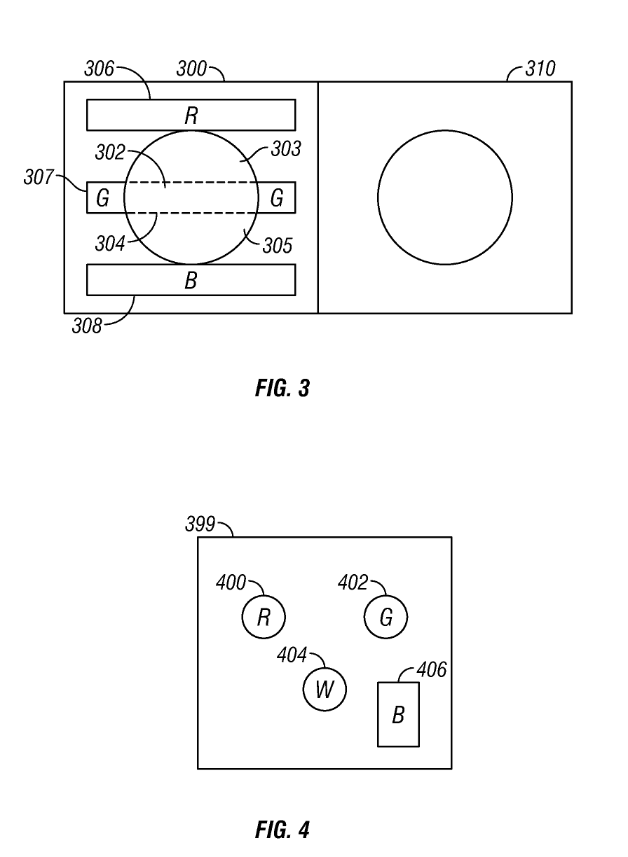

Another embodiment, shown in FIG. 3, uses a single large LED to form each pixel. For example, the pixels 300 and 310 each have a single LED therein. The LED 302 in pixel 300 is logically divided into three parts, a first part 303, a second part 304, and a third part 305. Each of these parts is associated with the respective filter. For example, the first part 303 may be associated with a red filter 306. The second part 304 may be associated with a green filter 307. The third part 305 may be associated with a blue filter 308. In each of these cases, the filters preferentially pass the color associated with that filter. Also in this embodiment, for purposes of geometry, some of the filters may be divided in two. For example, the green filter 370 shown as having half of the filtering capability at each end.

Preferably the LED is broken up so that the area covered by each filter is substantially the same. This will mean that the sizes of each of the three filters may be different sizes and/or cover different areas.

Yet another embodiment of FIG. 4 uses three LEDs as in the FIG. 1 embodiment, but recognizes that the blue LED is the one that most often degrades. Therefore, the three LEDs include a red LED 400, a green LED 402 and a white LED 404. The white LED 404 is associated with a flag 406 that forms a blue filter. The control of the pixel 399 may be otherwise the same as the control of the other pixels. Intensity modifications may be carried out in any of these embodiments to attempt to ensure that the intensity of all of the pixels is substantially the same.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other light emitting devices, including OLEDs and others can be used with this system. The above describes the “flags” as being glass, but they could alternatively be gel or plastic on a roll. Other colors can be used to avoid the

The lights described herein can be controlled by computers. These can be any kind of computer, either general purpose, or some specific purpose computer such as a workstation. The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A lighting system, comprising:
at least first, second and third light emitting diode elements, each of said first, second and third light emitting diode elements emitting light that is the same color, and
a structure which controls at least a subset of said first, second and third light emitting diodes to create different colors from the combination of said first, second and third light emitting diode elements.

2. A system as in claim 1, wherein said first, second and third light emitting diode elements are used together to create a single pixel of projection, and further comprising a plurality of additional light emitting diode elements used to create additional pixels of projection.

3. A system as in claim 1, wherein said structure that controls said colors includes color changing objects which each changes a color of one of the first, second and third light emitting diode elements, and further comprising a controller that controls said color changing objects.

4. A system as in claim 3, wherein said color changing object is a movable color filter.

5. A system as in claim 4, wherein said movable color filter can fully or partially cover each diode element.

6. A system as in claim 1, wherein said structure control said light emitting diodes to create different primary colors.

7. A system as in claim 6, wherein said primary colors are respectively red, green and blue.

8. A system as in claim 1, wherein said structure controls colors of each of said first, second and third light emitting diodes.

9. A structure as in a system as in claim 1, wherein said structure controls colors less than all of said light emitting diodes.

10. A structure as in claim 8, wherein one of said structures is red, one of said structures is green, and another of said structures is blue.

11. A lighting apparatus, comprising:
a light emitting diode, creating a single color output light; and
a light coloring structure which changes color of multiple different parts of said single output light to create different colors from said single output light.

12. A system as in claim 11, wherein said light emitting diode creates a single pixel of projection, and further comprising a plurality of additional light emitting diodes to create additional pixels of projection.

13. A system as in claim 11, wherein said light coloring structure includes multiple different color changing objects which each changes a color of only a portion of the single color output light.

14. A system as in claim 11, wherein at least one of said color changing objects is a different shape than another of said color changing objects.

15. A system as in claim 11, further comprising a controller that controls said color changing objects.

16. A system as in claim 13, wherein said color changing objects are movable color filters.

17. A system as in claim 16, wherein said color changing objects can fully or partially the light emitting diode.

18. A system as in claim 16, wherein said color changing objects control creating different primary colors.

19. A system as in claim 18, wherein said primary colors are respectively red green and blue.

20. A lighting system, comprising:
at least first, second and third light emitting diode elements;
a structure which changes a color of at least a subset of said first, second and third light emitting diodes to create different colors from the combination of said first, second and third light emitting diode elements.

21. A system as in claim 20, wherein said first, second and third light emitting diode elements are used together to create a single pixel of projection, and further comprising a plurality of additional light emitting diode elements used to create additional pixels of projection.

22. A system as in claim 20, wherein said structure that controls said colors includes color changing objects which each changes a color of each of the first, second and third light emitting diode elements.

23. A system as in claim 20, wherein said structure that controls said colors includes a single color changing object which only changes a color of a single one of the first, second and third light emitting diode elements.

24. A system as in claim 23, wherein said structure changes a color of only a white light emitting diode element.

25. A system as in claim 24, wherein said color changing object is a movable color filter.

26. A method, comprising:
emitting a single color of light from an LED light; and
changing said single color of light to multiple different colors of light based on a desired color of light using at least one light filter.

27. A method as in claim 26, further comprising obtaining multiple pixels of projection from multiple different changed in color LEDs.
